(19) United States
(12) Patent Application Publication
(10) Pub. No.: US 2020/0116547 A1
(43) Pub. Date: Apr. 16, 2020

(54) MATERIAL LOADING MANAGEMENT SYSTEM AND METHOD

(71) Applicant: Deere & Company, Moline, IL (US)

(72) Inventors: Lance R. Sherlock, Asbury, IA (US); Keith N. Chaston, Dubuque, IA (US); Drew F. Harwell, Dubuque, IA (US); Benjamin P. Koestler, Asbury, IA (US); Noel W. Anderson, Fargo, ND (US); Matthew J. Sbai, Dubuque, IA (US); David J. Myers, Cedar Falls, IA (US); Hatim A. Bookwala, Dubuque, IA (US); Kevin W. Campbell, Dubuque, IA (US); Thomas A. Porter, Dubuque, IA (US)

(21) Appl. No.: 16/159,664

(22) Filed: Oct. 14, 2018

(51) Int. Cl. G01G 19/02; G01G 23/00

(52) U.S. Cl. CPC G01G 19/021; G01G 23/18; G01G 23/005

(57) ABSTRACT

A system for managing material loading is disclosed herein. The system comprising a sensor arranged on or proximate a material loading machine that is configured to measure a weight of the material loading machine. A transmitting device communicatively coupled to the sensor that is configured to receive and transmit the measured weight to an electronic data processor. An electronic data processor coupled to each of the sensor and the transmitting device. The electronic data processor is configured to compute a material weight based on the measured weight of the material loading machine and generate an alert for display on a user interface when the material weight exceeds a predetermined threshold.

### RELATED APPLICATIONS

This application relates to U.S. patent Publication application Ser. No. 15/584177, titled “Smart Attachment for a Work Vehicle, filed May 2, 2017, which is hereby incorporated by reference in its entirety.

### FIELD OF THE DISCLOSURE

The present disclosure relates generally to loading systems and, more particularly, to a material loading management system and method.

### BACKGROUND OF THE DISCLOSURE

The management of worksite efficiency for off highway equipment such as construction, forestry, agricultural, or turf care equipment can be challenging. For example, with conventional systems, vehicle operators are unable to accurately record weight data or determine if maximum truck loads have been attained resulting in underloading and overloading of material loading trucks.

To address such concerns, there is a need in the art for an improved and cost-effective material loading system that increases worksite efficiency, measurement accuracy, and productivity.

### SUMMARY OF THE DISCLOSURE

According to an aspect of the present disclosure, a system for managing material loading is disclosed. The system comprising a sensor arranged on or proximate a material loading machine that is configured to measure a weight of the material loading machine. A transmitting device communicatively coupled to the sensor that is configured to receive and transmit the measured weight to an electronic data processor. An electronic data processor coupled to each of the sensor and the transmitting device. The electronic data processor is configured to compute a material weight based on the measured weight of the material loading machine and generate an alert for display on a user interface when the material weight exceeds a predetermined threshold.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is an illustration of a system for managing loading of one or more material loading machines according to an embodiment;

FIG. 2A is a side view of an attachment apparatus according to an embodiment;

FIG. 2B is a side view of an attachment apparatus according to an embodiment;

FIG. 2C is a side view of an attachment apparatus according to an embodiment;

FIG. 2D is a side view of an attachment apparatus according to an embodiment;

FIG. 3 is a block diagram of a material loading system according to an embodiment;

FIG. 4 is an illustration of a transmitting device arranged in the material loading system of FIG. 3 according to an embodiment;

FIG. 5 is a block diagram of a material loading system according to an embodiment;

FIG. 6 is an illustration of a tracking system in use at a worksite according to an embodiment;

FIG. 7 is an exemplary data table of parameters associated with the tracking system of FIG. 6; and

FIG. 8 is a flow diagram of a method for operating the material loading system of FIG. 1.

Like reference numerals are used to indicate like elements throughout the several figures.

### DETAILED DESCRIPTION OF THE DRAWINGS

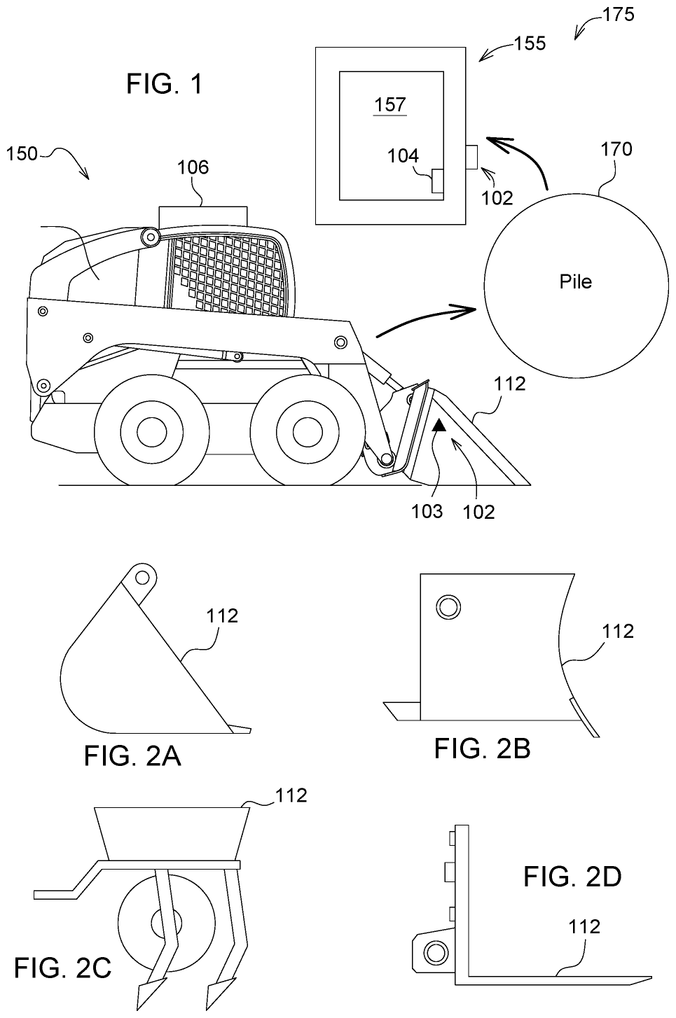

Referring to FIGS. 1-3, a system 100 for managing loading of one or more material loading machines located at a worksite 175 and a corresponding work vehicle is shown. In FIG. 1, a work vehicle 150 can be arranged to collect and transfer a quantity of material located in a pile 170 at the worksite 175. For example, in some embodiments, the work vehicle 150 can include a skid steer (FIG. 1) having an attachment apparatus 112 attached thereto that collects material from the pile 170 for loading into a loading bed 157 (e.g., a bin or hopper) of the material loading machine 155.

The material loading machine 155 can comprise a variety of suitable loading apparatuses or machines such as, for example, articulated dump trucks, trailers, or bulk storage bins. In various embodiments, the attachment apparatus 112 can comprise an implement or one or more ground engaging devices such as, for example, loader buckets, rippers, hammers, forks, planter row units, or other suitable working tools (refer, e.g., to FIGS. 2A-2D). It should be noted however, that other transfer vehicles (i.e., work vehicles) may be used in a variety of applications such as discussed herein.

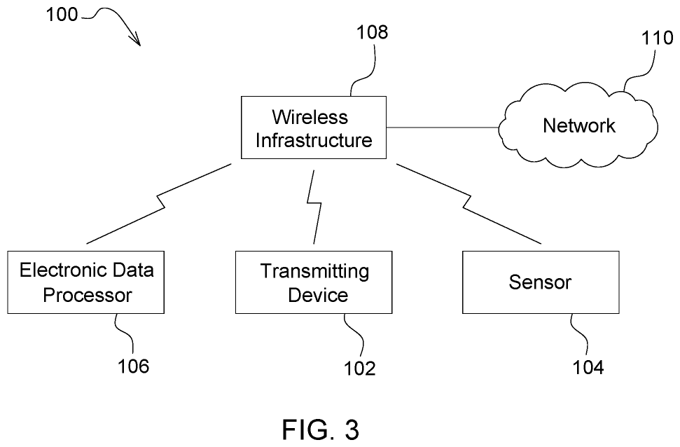

As shown in FIG. 3, in some embodiments, the system 100 can comprise at least one sensor 104 coupled to the material loading machine 155, a transmitting device 102 associated with the material loading machine 155 or the attachment apparatus 112, each communicatively coupled to an electronic data processor 106 via a communication network 110. The communication network 110 can comprise the Internet, a public switched telephone network (PSTN) or another public, or private electronic communication network 110, or a communications link (e.g., telecommunications line or microwave link) that supports communication to or from a wireless infrastructure 108.

The sensor 104 can include, without limitation, load cells, force sensors, pressure sensors, level sensors, or other suitable sensors, which may vary according to application and/or specification requirements. For example, in some embodiments, the sensor 104 can vary based on the type of material (e.g., concrete versus compacted soil) that is loaded into the material loading machine 155. It should also be noted that the location and arrangement of the sensor 104 can also vary in embodiments. For example, although the sensor 104 is shown as being arranged on an external surface of the material loading machine 155, in other embodiments, the sensor 104 can be arranged proximate to the material loading machine 155 (e.g., on a separate loading machine) or located internally within the loading bed 157.

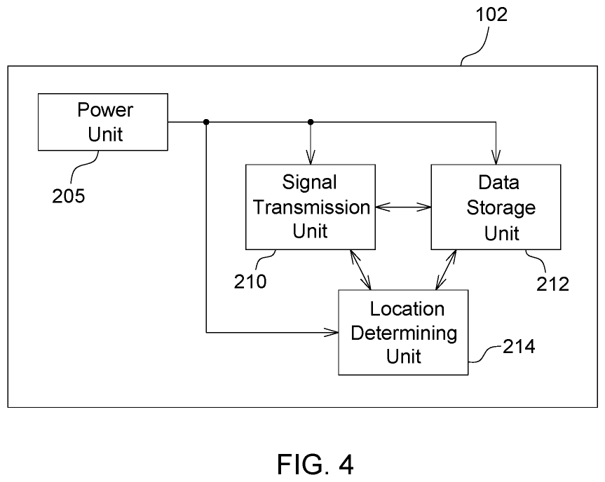

The transmitting device 102 can be coupled to or arranged proximate the material loading machine 155, and can comprise a beacon device such as that described in commonly-assigned co-pending U.S. patent application Ser. No. 15/584177. In some embodiments, the transmitting device 102 can comprise one or more comprise internal circuit components arranged in a housing 103 and can be configured to transmit weight information received from the sensor 104 to the electronic data processor 106, as will be discussed in further detail with reference to FIG. 4.

In some embodiments, the electronic data processor 106 can be arranged locally in a vehicle electronics unit 120 or remotely in a remote processing system 130. The electronic data processor 106 can be configured to associate and process data received from each of the transmitting devices 102 and the sensor 104. In some embodiments, the electronic data processor 106 can be configured to receive information wirelessly (e.g., Bluetooth, Wi-Fi, near-field, etc.) via the wireless infrastructure 108 or via wired connections.

In various embodiments, the electronic data processor 134 can comprise a microprocessor, a microcontroller, a central processing unit, a programmable logic array, a programmable logic controller, an application specific integrated circuit, a logic circuit, an arithmetic logic unit, or another data processing system for processing, storing, retrieving, or manipulating electronic data associated with the transmitting device 102 and sensor 104. For example, as material is loaded and unloaded into the loading bed 157, payload information can be sensed, recorded, and transmitted by the sensor 104 to the transmitting device 102 and/or the electronic data processor 106.

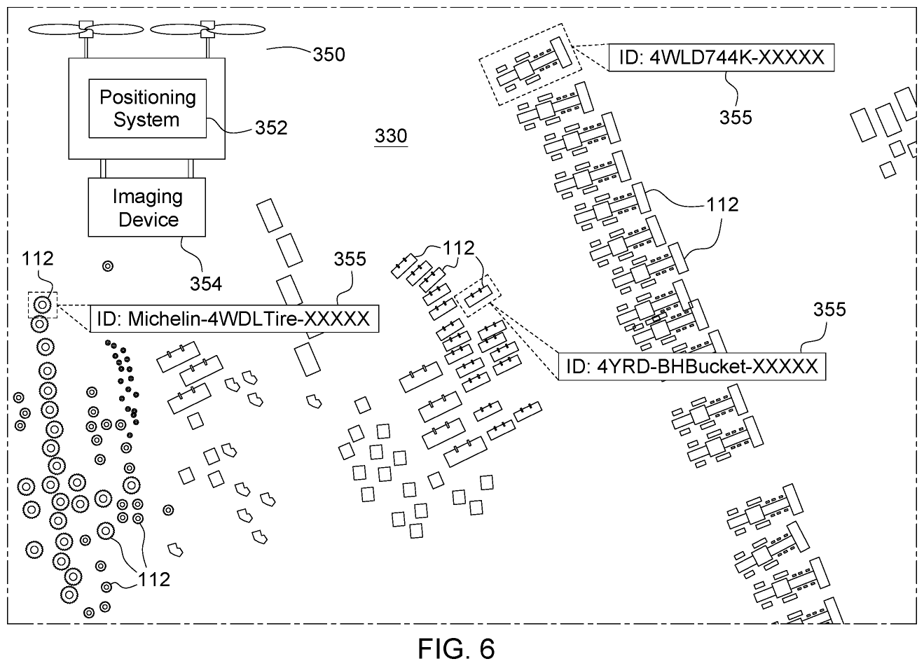

With respect to FIGS. 1-3, it will be appreciated by those skilled in the art that FIGS. 1-3 are not drawn to scale and is for illustrative purposes only to demonstrate exemplary embodiments of the present disclosure. Notably, the structural layout and/or quantity of the various components can and will vary in other embodiments. For example, as will be discussed with reference to FIG. 6, in some embodiments, system 100 can further comprise one or more unmanned aerial vehicles. In other embodiments, two or more transmitting devices can be arranged on the attachment apparatus 112 in a variety of locations according to design and/or application requirements. Additionally, although in embodiments discussed herein, the system 100 will be shown as being used in construction applications, it should be noted that the universal design of system 100 allows for use in a variety of applications and systems. For example, in other embodiments, the system 100 can be employed in agricultural turf, and/or forestry applications.

Referring now to FIG. 4, as previously discussed, the transmitting device 102 can comprise internal circuit components such as a data storage unit 212, a signal transmission unit 210, and a location determining unit 214 collectively arranged in the housing 103. As shown in FIG. 1, the housing 103 can be sized and dimensioned for placement on a surface of the material loading machine 155 or the attachment apparatus 112. A power unit 205 (e.g., an AC or DC power source) can be arranged to supply power to the various components of the transmitting device 102, and can comprise a variety of connectors such as battery connectors, terminal blocks, and/or three phase power connectors. In other embodiments, the transmitting device 102 can comprise other suitable sensors such as, for example, imaging or infrared sensors which can be utilized to recognize structural features and characteristics of the material loading machine 155 or the attachment apparatus 112.

In some embodiments, the data storage unit 212 can comprise a non-transitory storage media or memory such as, without limitation, nonvolatile random-access memory, an optical storage device, a magnetic storage device, or another device for storing and accessing electronic data on any recordable, rewritable, or readable electronic, optical, or magnetic storage medium. The data storage unit 212 can be configured to store weight information associated with the material loading machine 155, device identification codes associated with the attachment apparatus 112, or other device data. For example, as material is loaded into the loading bed 157 of the material loading machine 155, weight information such as tare weight, current weight, and maximum weight can be transmitted from the sensor 104 and stored in the data storage unit 212. Additionally, in other embodiments, the data storage unit 212 can comprise an internal clock or counter that allows for movement or other data to be recorded and associated with a date and/or time stamp.

The signal transmission unit 210 can be configured to transmit one or more data signals, either automatically or in response to receipt of a polling signal, containing the received weight information or other device specific data in relation to the material loading machine 155 or the attachment apparatus 112. In some embodiments, the signal transmission unit 210 can be configured to transmit the one or more data signals at regular intervals for a predetermined time duration. Additionally, the signal transmission unit 210 can be configured for unidirectional or bi-directional communication. For example, in some embodiments, the signal transmission unit 210 can comprise a transceiver that is configured to send and receive one or more data signals wirelessly over the communication network 110. In other embodiments, the signal transmission unit 210 can comprise a transmitter that transmits the one or more data signals to receiving devices arranged on the sensor 104 or the vehicle electronics unit 120.

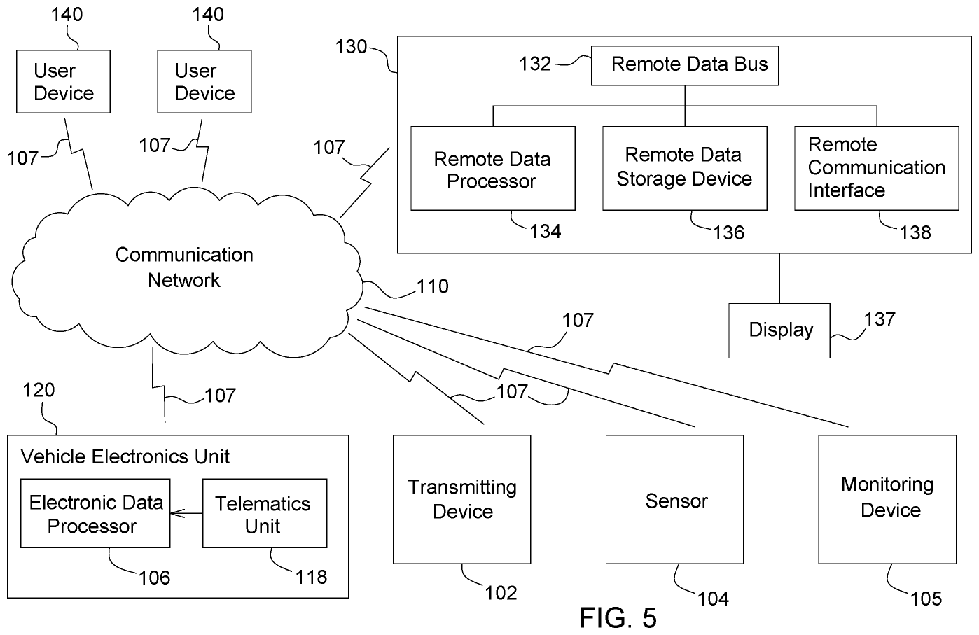

To determine the location and position of the transmitting device 102, the location determining unit 214 can be configured to receive a plurality of positioning signals from one or more satellites (not shown). Such information can be transmitted to the electronic data processor 106, displayed on user displays arranged in the work vehicle 150 or on other suitable graphical user interfaces, or can also be transmitted to a telematics unit 118 as will be discussed in FIG. 5.

Referring now to FIG. 5, in other embodiments, system 100 also can be configured to provide equipment management capabilities such as inventory tracking. In FIG. 5, a system 200 is shown, which is substantially similar to system 100, but further comprises a monitoring device 105, a telematics unit 118, the remote processing system 130, and a plurality of user devices 140.

As depicted in FIG. 5, the remote processing system 130 can be communicatively coupled to the vehicle electronic unit 120, the transmitting device 102, the sensor 104, the monitoring device 105, and user devices 140 via the communication network 110 and wireless links 107. In some embodiments, the remote processing system 130 can comprise a remote data processor 134, a remote data storage device 136, and a remote communications interface 138 coupled to a remote data bus 132 and may be implemented by a general-purpose computer or a server that is programmed with software modules stored in the remote data storage device 136.

The remote processing system 130 can further comprise a user display 137 that allows such information to be displayed for view by an operator or equipment owner. For example, the displayed data can be used by a customer or equipment owner to monitor material weight data as the material loading machine 155 is being filled. In other embodiments, the displayed data can be used to determine if a specific attachment apparatus 112 is being used or is near its end of life, as well as to determine its corresponding location. In still other embodiments, the data can be transmitted from the remote processing system 130 to the one or more user devices 140 for display. The user devices 140 can comprise one or more of personal digital assistants, laptop computers, cellular phones or other handheld devices, combinations thereof, or other suitable communication devices capable of establishing a communication link over the communication network 110.

The monitoring device 105 can be arranged on or proximate the work vehicle 150 within proximity to the transmitting device 102 and can be configured to monitor machine functions and/or parameters such as pressure, flow rate, operating state, engine load, valve position, for example. In some embodiments, the monitoring device 105 can be arranged as part of a telematics unit 118, while in other embodiments, the monitoring device 105 can be arranged remotely such as on a separate vehicle or at a remote processing system 130 (FIG. 5).

The telematics unit 118 can be configured to collect data from the vehicle electronics unit 120 and/or the transmitting device 102 and communicates the data over the communication network 110 to the remote processing system 130 for storage or display. For example, the telematics unit 118 can comprise a system such as JDLink that is used to provide a diverse range of vehicle services. In some embodiments, the telematics unit 118 can receive device identification and location data directly from each of the transmitting devices 102, whereas, in other embodiments, it can receive the associated data (e.g., identification and use data) provided by the vehicle electronics unit 120. In either embodiment, the received data can be transmitted to the remote processing system 130 for processing.

Referring to FIG. 6, a system 300 is shown according to an embodiment. The system 300 is substantially similar to systems 100 and 200, therefore like reference numerals will be used and certain features will not be discussed in detail. System 300 further comprises one or more unmanned aerial vehicles 350 configured to generate imaging data of the attachment apparatus 112 or material loading machine 155 and the surrounding field area 330. The unmanned aerial vehicle 350 can comprise an onboard processing and a communication system that allows the unmanned aerial vehicle 350 to communicate wirelessly (e.g., Bluetooth, near infrared, WLAN, others) with each of sensor 104, the transmitting device 102, the vehicle electronics unit 120, and/or the remote processing system 130.

As depicted in FIG. 6, the unmanned aerial vehicle 350 can be arranged to aerially survey or travel over the field area 330 and can comprise an imaging device 354 that captures the imaging, location, and identification data associated with each attachment apparatus 112. It should also be noted that use of the unmanned aerial vehicle 350 provides for greater sensing capabilities. For example, the positioning system 352 of the unmanned aerial vehicle 350 allows for location data to be provided regardless of visibility conditions, which provides for greater sensing capabilities.

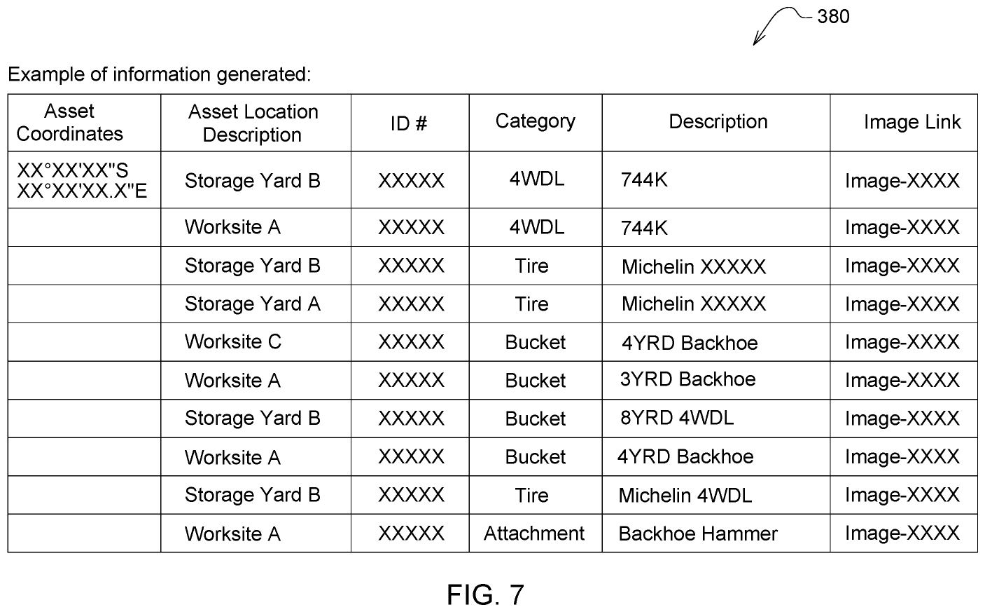

The captured data can be stored in tabular form such as that illustrated in FIG. 7 in a remote data storage unit (not shown) of the remote processing system 130. For example, a data table such as table 600 can be configured to store lists of location and identification data associated with each attachment apparatus 112, which can include: asset coordinates, asset location description, identification number, category description, and image link. The stored data can be used to generate device identification tags 355 as shown in FIG. 6.

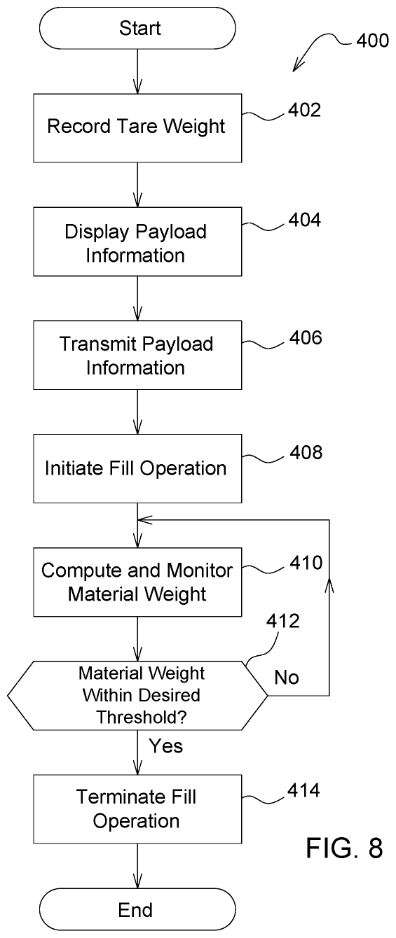

Referring to FIG. 8, a flow diagram of a method 400 for performing the operations of the material loading system 100 is shown. In operation, at step 402, as the material loading machine 155 crosses a scale (not shown) arranged at the worksite 175, an initial tare weight (i.e., first weight) is recorded by the sensor 102. At step 404, as the material loading machine 155 approaches the pile 170, the material loading machine 155 communicates payload data (i.e., loading capacity and/or weight information) to the work vehicle 150. For example, in some embodiments, the payload data can be communicated to the telematics unit 118 or the vehicle electronics unit 120 arranged on the work vehicle 150 via the transmitting device 102.

Once the payload data is received by the telematics unit 118 or the vehicle electronics unit 120, the payload data is then transmitted to a user interface such as user device 140 for display at 406. Next at 408, an operator initiates a fill operation based on the information (i.e., payload data) displayed on the user device 140 (user interface arranged in a vehicle) (user device could be a handheld device used as a secondary display for an operator standing in a field). At 410, as material is loaded into the loading bed 157 of the material loading machine 155 by the work vehicle 150, a weight of the material loading machine 155 is measured by the sensor 104 and transmitted to the electronic data processor 106 via the transmitting device 102. Based on the measured data, the electronic data processor 106 computes a corresponding material weight. At 412, a decision is made to determine if the computed material weight is within a predetermined threshold defined based on the initial tare weight. If the material weight is below the predetermined threshold, the fill operation continues and the material weight is continusouly monitored by the sensor 104. Otherwise, if the material weight is within the predetermined threshold, the fill operation is terminated at 414. Additionally, the fill operation is also terminated if the material weight exceeds the predetermined threshold and an operator alert is generated.

In other embodiments, as discussed with reference to FIG. 4, the transmitting device 102 can also be configured to periodically transmits its location and identification data to a remote device such as the vehicle electronics unit 120, or the remote data processor 134 for association with a measured machine parameter. For example, for a hydraulically controlled attachment apparatus such as a hammer, the monitoring device 105 can be configured to measure machine parameters such as flow rate and system pressure, whereas, for attachment apparatuses such as loader buckets, the monitoring device 105 can be configured to measure boost pressure. Once the information is received and associated, the electronic data processor 106 can determine an amount of use or productivity of the attachment apparatus 112 by associating the location and identification of the transmitting device 102 with the machine parameters measured by the monitoring device 105.

In still other embodiments, the material loading system 100 can include an additional search and find mode that allows an operator to use information transmitted via the transmitting device 102 to select a specific attachment apparatus 112 from a monitor list displayed on the user device 140. For example, in such an operational mode, as a vehicle operator travels across a worksite searching for one or more attachment apparatuses, a pop up screen or alarm can be generated by the vehicle electronics unit 120 when the work vehicle 150 is within a certain distance of the selected attachment apparatus. In yet other embodiments, the transmitting device 102 can also be used to alert (e.g., theft or rental notifications) a vehicle operator of a changeout or checkout of an attachment apparatus 112 or material loading machine 155 by monitoring engagement and/or disengagement of the attachment apparatus during or following a material loading operation.

Without in any way limiting the scope, interpretation, or application of the claims appearing below, a technical effect of one or more of the example embodiments disclosed herein is a material loading management system and method. Such an arrangement is particularly advantageous in that it increases worksite efficiency by solving the problem of under loading or overloading a truck by notifying the loading machine's operator when the truck's maximum load has been attained. This helps to reduce wasted time adding or removing load from the material loading machine, in addition to assuring compliance with Department of Transportation weight limits.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A system for managing material loading, the system comprising:
a sensor arranged on or proximate a material loading machine, wherein the sensor is configured to measure a weight of the material loading machine;
a transmitting device communicatively coupled to the sensor, wherein the transmitting device is configured to receive and transmit the measured weight; and
an electronic data processor coupled to each of the sensor and the transmitting device, wherein the electronic data processor is configured to compute a material weight based on the measured weight of the material loading machine and generate an alert for display on a user interface when the material weight exceeds a predetermined threshold.

2. The system of claim 1, wherein the material loading machine comprises one or more of the following: articulated dump trucks, trailers, bulk storage bins, or combinations thereof.

3. The system of claim 1, further comprising associating the material weight with a location of the transmitting device.

4. The system of claim 1, wherein the material loading machine comprises a loading bed for receiving a quantity of material from a work vehicle.

5. The system of claim 3, wherein the transmitting device is coupled to the loading bed or an attachment apparatus.

6. The system of claim 1, wherein the sensor comprises one or more of the following: load cells, force sensors, pressure sensors, level sensors, or combinations thereof.

7. The system of claim 1, wherein the electronic data processor is further configured to generate an inventory map of one or more material loading machines and attachment apparatuses located at a worksite.

8. The system of claim 1, wherein the sensor is configured to measure a first weight of the material loading machine in an unfilled state, and wherein the sensor is configured to measure a second weight of the material loading machine in a fill state.

9. The system of claim 1, wherein the electronic data processor is arranged in a vehicle electronics unit.

10. A method for managing material loading, the method comprising:
measuring a first weight of a material loading machine in a first operating state;
measuring a second weight of a material loading machine in a second operating state;
computing a material weight based on the measured first weight and second weight;
correlating the material weight to a predetermined threshold defined based on the first weight; and
generating an operator alert if the material weight exceeds the predetermined threshold.

11. The method of claim 10, wherein measuring a first weight of a material loading machine in a first operating state comprises measuring a tare weight of the material loading machine in an unfilled state.

12. The method of claim 10, wherein measuring a second weight of a material loading machine in a second operating state comprises measuring a weight of the material loading machine in a fill state.

13. The method of claim 10, wherein the first weight and the second weight are measured using one or more of the following: load cells, force sensors, pressure sensors, level sensors, or combinations thereof.

14. The method of claim 10, wherein generating an operator alert further comprising terminating a fill operation of the material loading machine when the material weight exceeds the predetermined threshold.

15. The method of claim 10, further comprising determining an amount of use or productivity of the material loading machine or an attachment apparatus by associating a location and identification of a transmitting device with one or more machine parameters of a work vehicle.

16. The method of claim 10, further comprising monitoring a changeover or checkout of the material loading machine by monitoring engagement and/or disengagement of an attachment apparatus during or following a fill operation.

17. The method of claim 15, further comprising generating an operator alert corresponding to a theft or rental of the material loading machine based on the monitored engagement and/or disengagement.
